(19) United States
(12) Patent Application Publication
(10) Pub. No.: US 2003/0059342 A1
(43) Pub. Date: Mar. 27, 2003

(54) Pocket analyser

(76) Inventor: Jerome L. Elkind, Richardson, TX (US)

Correspondence Address: TEXAS INSTRUMENTS INCORPORATED, P O BOX 655474, M/S 3999, DALLAS, TX, 75265

(21) Appl. No.: 09/965,140

(22) Filed: Sep. 26, 2001

(51) Int. Cl. G01N 27/00

(52) U.S. Cl. 422/82.01; 204/406; 204/409; 73/61.49

(57) ABSTRACT

An agitated flow cell had a micro/miniature vibrator device such as pager motor to agitate the flow cell and its associated sensor to bring fresh analyte to the sensor surface without the need for microfluidic channels, pumps or valves. The agitated flow cell improves the confidence measure of a given sample reading by directing the flow of sample to the sensor/sample interface in a substantially shorter period of time than that required by flow cells that rely on diffusion of analyte molecules through the liquid depletion region in order to bring the sample reliably in contact with the sensor's biosensing film.

### BACKGROUND OF THE INVENTION

1. Field of the Invention

This invention relates generally to analytical testing instrumentation, and more particularly to an agitated well or fluid chamber having a micro/miniature vibrator device such as a pager motor to agitate the well/fluid chamber, its contents and its associated sensor to enable mixing of dehydrated reagents and bring analyte to the sensor surface without the need for microfluidic channels, pumps or valves.

2. Description of the Prior Art

Most analytical measurements have historically been made in a central laboratory, on sophisticated equipment by highly trained personnel. Modem trends have demonstrated a need for a more de-centralized testing methodology where analytical measurements are actually made at the sample collection site, since this is generally the place where the results are needed.

One miniaturized sensor platform with integrated channels for controlling the flow of sample over a sensor/sample interface that is available from Texas Instruments Incorporated of Dallas, Tex., provides one low-cost, portable electronic biosensor platform that accommodates such de-centralized testing. This sensor platform incorporates a miniature surface plasmon resonance (SPR) sensor. By measuring the light reflection properties of a gold surface as targeted molecules bind to it, real-time detection of these targeted molecules is possible. This sensor platform is described in detail in U.S. Pat. No. 6,183,696, entitled Optically based miniaturized sensor with integrated fluidics, issued on Feb. 6, 2001 to Elkind et al., assigned to the assignee of the present invention, and is incorporated in its entirety by reference herein While miniaturized sensors are becoming available for use in a wide range of field applications, their effectiveness as an analytical tool is largely determined by the properties of the sample analyte of interest, including molecular weight, concentration, sample matrix, isoelectric point, solubility and stability. Fluctuations in sample concentration, temperature and other environmental conditions affect the reactive properties of film deposit in the presence of the sample. Ideally, a controlled amount of the sample with uniform properties is brought in contact with the sensor/sample interface during the sampling process. With larger systems, a flow cell may be used to control the flow rate of the sample.

In general, analyte molecules that are dissolved or suspended within the liquid must make contact with the sensing surface of the biosensor in order to provide accurate measurements of any analyte. Usually, this process requires that the analyte molecules diffuse to the surface of the biosensor interface making contact with the liquid. This can be a very slow process, depending on the size of the analyte particles. Smaller molecules move faster through the liquid, while protein molecules, for example, move more slowly. Molecules having beads attached for amplification, or microorganisms such as E coli are comparatively large, and therefore move more slowly through the liquid by a process known as shear-enhanced diffusivity. This slow transport process has been addressed in the prior art by use of high flow rates to accelerate the mass transport flux of analyte to the biosensor surface, rather than relying simply on the diffusion process, alone. In addition, recirculation of the sample can accommodate testing of small sample volumes. Although such flow systems have improved the sensitivity and reliability of biosensor measurements, these flow systems have been problematic. This is because these known flow systems use tubular flow structures that are characterized by a center region where liquid is flowing and an outer (edge, or depletion) region that can be several microns thick where there is no flow. Since this depletion region is static (has no laminar flow), the diffusion process described above must still be relied upon in order to ensure that reagents pass through the depletion region to make contact with the sensing surface of the biosensor. This diffusion process can be undesirably time consuming. In addition, these peripheral technologies add a great deal of bulk and cost to the instrument.

In view of the foregoing, a need exists for an inexpensive or ultra-low-cost analytical instrument that employs a compartmentalized fluid chamber with an associated biosensor that is both accurate and user-friendly (i.e. easy to use) but that does not rely on complex peripheral technologies. The analytical instrument enables sample/reagent mixing and high mass transport of analyte to the sensor surface within an agitated compartmentalized fluid chamber that incorporates features necessary for temperature compensated, multichannel detection, including memory to hold specific test protocols.

### SUMMARY OF THE INVENTION

The present invention is directed to an agitated well or fluid chamber having a micro/miniature vibrator device such as pager motor to agitate the well/fluid chamber and its associated sensor to enhance mass transport of analyte to the sensor surface without the need for microfluidic channels, pumps or valves. The agitated well/fluid chamber improves the sensitivity and reduces sampling time by accelerating the mass transport flux of analyte to the sensor surface. Flow cells that rely on convective and diffusional mass transport of analyte suffer from poor sensitivity and extended sampling times.

According to one aspect of the invention, an agitated well/fluid chamber is implemented to eliminate the need for pumps and other peripheral technology thereby being inexpensive and easy to use.

According to another aspect of the invention, an agitated well/fluid chamber is implemented to enable rapid mass transport of analyte to maximize sensitivity and reduce sample time.

According to yet another aspect of the invention, an agitated well/fluid chamber is implemented to allow analytical measurements to be made at the site where samples are collected by exploiting simplified assay methodologies.

According to still another aspect of the invention, an agitated well/fluid chamber is implemented without use of microfluidic channels, pumps or valves to ensure the instrument is fully portable and easily held in hand so as to allow analytical measurements to be made at the site where liquid samples are collected.

### BRIEF DESCRIPTION OF THE DRAWINGS

Other aspects, features and advantages of the present invention will be readily appreciated, as the invention becomes better understood by reference to the following detailed description when considered in connection with the accompanying drawing figures wherein:

FIG. 1 illustrates a prior art SPR miniaturized sensor package;

FIG. 2 illustrates a perspective view of a prior art flow channel sensor; and

FIG. 3 is a diagram illustrating a pocket analyzer having an agitated well/fluid chamber and associated biosensor platform that brings fresh analyte to a biosensor surface without the need for microfluidic channels, pumps or valves, according to one embodiment of the present invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

FIG. 1 illustrates a prior art integrally formed optically based Surface Plasmon Resonance (SPR) sensor 50 in close proximity to a sample 25 analyte of interest that is a liquid. The sample 25 may be any liquid (bio)chemical substance for which an indicator interaction is known and which can be formed into thin biosensing layer 61. The film is deposited on a surface 63 of the sensor and exposed to the sample 25 during analysis. Various ways of bringing the sample 25 in contact with the surface 63 may be employed such as by dipping, dropping or by using a flow cell.

As shown, a substrate 52 forms a device platform to which a light transmissive housing 56 is coupled. The housing material can be plastic, glass or other similar optic coupling substance. A light source is preferably located above or within the substrate 52 and has an aperture 58 there over allowing light to pass. In one embodiment, the light source is a single high intensity light emitting diode. A polarizer 62 is located near the aperture 58 to polarize passing light which, in turn, continues through housing 56 and strikes a SPR layer 64 which is preferably formed on an exterior surface of the housing 56.

The SPR layer 64 may be deposited directly or placed on a glass slide or the like. This configuration achieves an optical surface phenomenon that can be observed when the polarized light is totally internally reflected from the interface between the layer 64 and the sample of interest. This principle is well understood by those skilled in the art and discussed by Ralph C. Jorgensen, Chuck Jung, Sinclair S. Yee, and Lloyd W. Burgess, in their article entitled Multi-wavelength surface plasmon resonance as an optical sensor for characterizing the complex refractive indices of chemical samples, Sensors and Actuators B, 13-14, pp. 721-722, 1993.

Analysis is permitted by using a mirrored surface 66 which directs the reflected light onto a detector array 68. The detector array 68, in turn, senses illumination intensity of the reflected light rays. For optical radiation, a suitable photodetector array 68 is the TSL213, TSL401 and TSL1401, with a linear array of resolution n times 1, consisting of n discrete photo sensing areas, or pixels. In the detector array 68, light energy striking a pixel generates electron-hole pairs in the region under the pixel. The field generated by the bias on the pixel causes the electrons to collect in the element while the holes are swept into the substrate.

Each sensing area in the photodetector array 68 thereby produces a signal on an output with a voltage that is proportional to the intensity of the radiation striking the photodetector 68. This intensity and its corresponding voltage are at their maxima in the total internal reflection region. Electrical connections 54 are coupled to one end of the substrate 52 and provide signal pathways from the detector 68 output to the external world.

As stated herein before, the sensing approach illustrated in FIG. 1, wherein the sample 25 is brought in contact 30 with the SPR layer 64 for analysis, may lead to unreliable results since analysis is influenced primarily by the properties of the sample 25. The sample concentration, for example, may vary throughout the sample mass or with time. Likewise, movement of the sensor 50 during analysis changes the orientation of layer 64 with respect to the sample 25. This is especially true in portable hand held applications where the sensor 50 is brought to the sample.

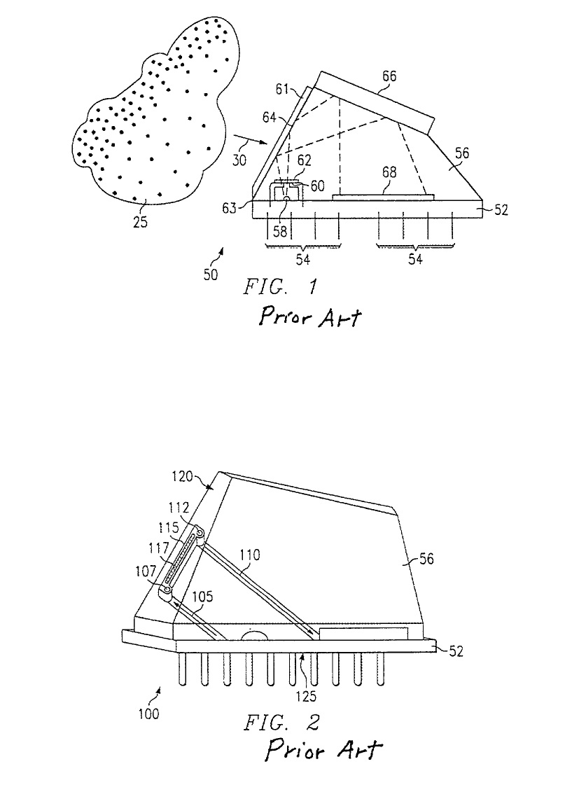

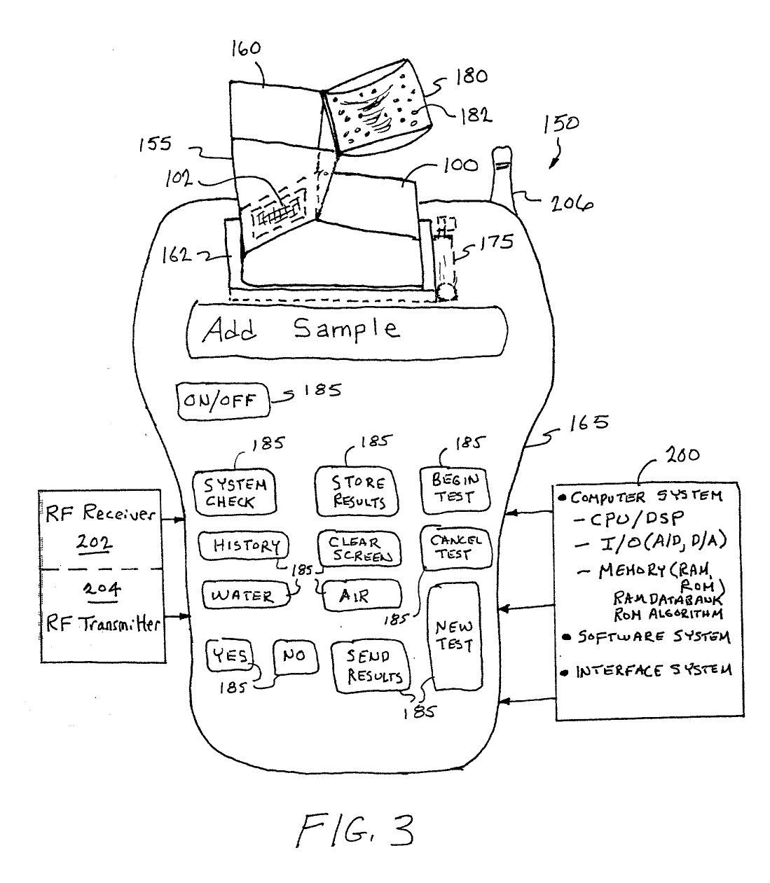

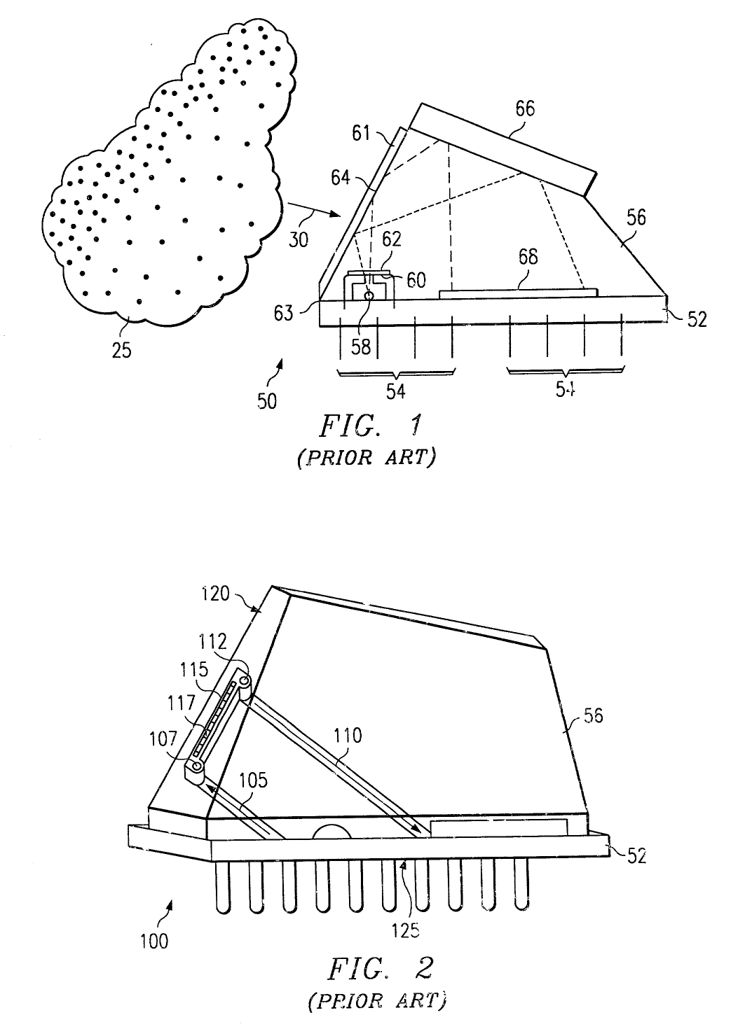

FIG. 2 illustrates a perspective view of a prior art flow channel sensor 100 that addresses many of the problems associated with the approach discussed above with reference to FIG. 1. Sensor 100 is similar to sensor 50 in most respects, but differs primarily by the integrally formed flow channels 105 and 110 inside the housing structure 56. As shown, the channels 105, 110 extend inside the housing 56 from a first surface 120 to a second surface 125 and pierce the platform 52 to the outside. This permits the sample to flow inside the sensor housing 56 through channel 105 and enter the cavity 115 via the opening 107. The sample flows over the metal film 117 which is deposited by known means on the bottom surface of the cavity 115. A more detailed discussion of sensor 100 including its principles of operation is set forth in the '696 patent referenced herein before, and so will not be discussed in further detail herein to preserve clarity and brevity.

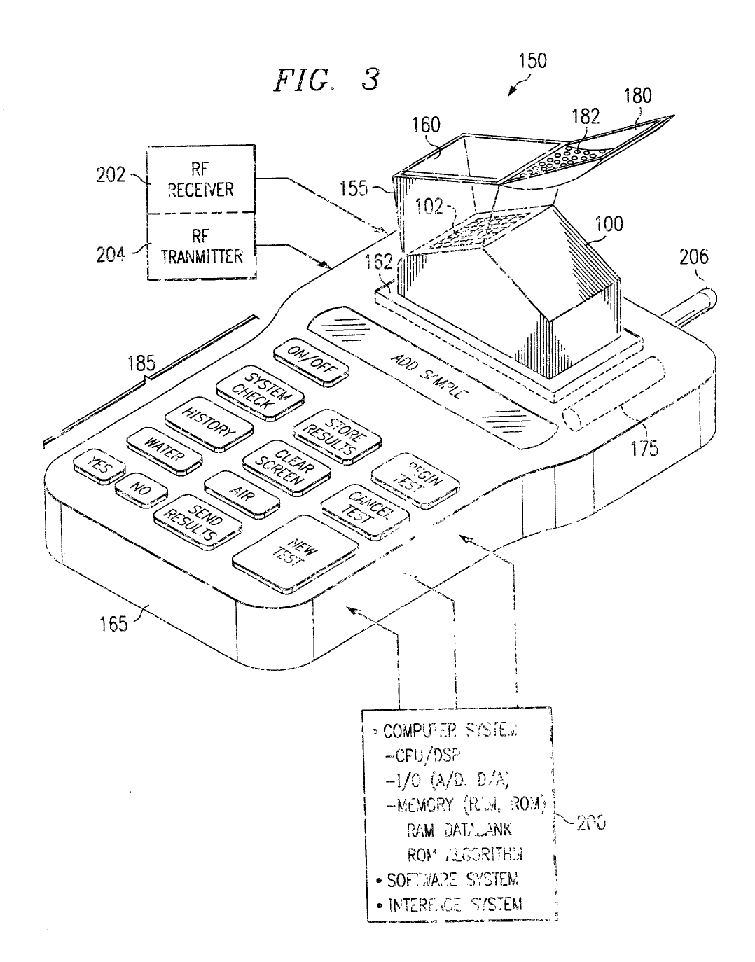

Looking now at FIG. 3, a perspective diagram illustrates a pocket analyzer 150 having an agitated well/fluid chamber 155 and a micro/miniature vibrator device 175 such as pager motor to agitate the well/fluid chamber 155 and its associated biosensor 100 to enhance both mixing and mass transport of the analyte 25 to the sensor 100 surface without the need for microfluidic channels, pumps or valves. A sample dispenser may be used to place the particular sample analyte 25 of interest into the well/fluid chamber 155 of the analyzer 150. Other methods and means of introducing the sample analyte 25 to the analyzer 150 are also contemplated.

In one embodiment, the fluid chamber 155 is open at end 160. This allows the sample analyte 25 to be gravity guided to the sensor 100. Alternatively, a pressure or vacuum means can be provided inside the instrument 150 to direct the sample to the sensor 100.

As shown, analyzer 150 has a base 165 which houses a sensor socket 162 inside. In some contemplated applications, the sensor 100 is housed inside the base 165.

In one contemplated use of the analyzer 150, the sensor 100 is plugged into the sensor socket 162 prior to use. The sample analyte 25 is then introduced into the well/fluid chamber 155 and analysis of the sample 25 is then performed according to well-known methods. Following analysis, the sensor 100 can be removed, replaced or optionally disposed of.

The analyzer 150 can also be seen to have a miniature electromechanical vibration device 175 attached to the sensor socket 162 that can be, for example, a pager motor (commonly used in cellular telephones and pocket pagers), to rigorously vibrate the well/fluid chamber 155 and/or the sensor 100 during the sample analysis process. The present invention is not so limited however, and it will be appreciated that other vibration means such as, for example, a piezo-electric crystal can just as easily be used to implement the requisite agitation. This agitation of the well/fluid chamber 155 and/or the sensor 100 provides a very simple and cost effective way to accelerate the reaction or binding process taking place in the sample 25 such that the reaction or binding process is no longer dependent upon convective and diffusional transport to deliver. The vibration device 175, in the embodiment shown, is attached to the sensor socket 162 inside the analyzer 150 such that when the vibration device 175 is energized, the socket will then shake the attached well/fluid chamber 155 and/or its associated sensor 100 depending upon the mechanical arrangement of the well/fluid chamber 155 and the sensor 100. The well/fluid chamber 155 and sensor socket 162 can be formulated as a unitary device such that the vibration device 175 will shake both the well/fluid chamber 155 and the sensor 100 when activated. The well/fluid chamber 155 can also be distinct from the sensor socket 162 such that only the sensor 100 will shake when the vibration device 175 is activated. More than one vibration device 175 can also be employed such that a well/fluid chamber 155 that is physically separated from the sensor 100 can be shaken independently.

With continued reference to FIG. 3, the well/fluid chamber 155 can be seen to have a hinged cap 180 that can be opened to allow filling the well/fluid chamber 155 with the sample solution 25 of interest that contains a suspended analyte. The hinged cap 180 may optionally have secondary analytes 182 embedded in storage compartments such that when the hinged cap 180 is closed to seal the sample solution 25, the secondary analytes 182 will be released into the sample solution 25 during the agitation process. Such secondary analytes 182 can be, for example, reagents such as biomolecular reagents that are useful to amplify, sensitize and help specify the analyte(s) during the analysis process. The present invention is not so limited however, and it shall be understood that other means for selectively sealing the fluid chamber 155 can also be effectively employed. The cap 180, for example, could instead be a septum with a rubber cap that can be temporarily punctured with a needle so that sample(s) can be injected; then upon removing the needle from the septum, the septum self-seals. If the fluid chamber 155 is evacuated, that vacuum could be used to draw liquid sample(s) into the fluid chamber 55 through the septum. Further, it is contemplated that one or more extra reagents may just as well be hid within the fluid chamber 155 such as, for example, embedding the reagent(s) within one or more of the chamber walls, or putting one or more solid samples in the fluid chamber 155.

The analyzer 150 further includes the requisite data processing device such as, for example, a DSP or microprocessor, appropriate input/output devices such as A/Ds and D/As, and data storage devices such as RAM to accommodate data storage and ROM to accommodate storage of the algorithmic software that is employed for hardware control and to perform the desired sample analysis. The flow of the sample solution 25 and other instrument functions may be controlled with user input keys 185 that can be used to implement modifications to the algorithmic software. FIG. 3 depicts a computer system 200 that is internal to the analyzer 150 and includes a data processing device (CPU/DSP), a data input device (A/D) in communication with the data processing device, an algorithmic software directing the data processing device, and a data storage unit (RAM Databank), wherein discrete analyte data associated with the liquid sample 25 is stored and supplied to the data processing device such that the data processing device, directed by the algorithmic software, will automatically determine bioanalytical data associated with the liquid sample, wherein predetermined parameters associated with the bioanalytical data are determined via the user input keys 185. It is also contemplated the analyzer 150 is capable of wireless connectivity/data transmission using conventional data communication techniques well-known in the art. The analyzer depicted in FIG. 3, for example, can be seen to have an RF receiver 202 and RF transmitter 204, both in communication with the computer system 200. An antenna 206 is used to both receive and transmit the desired information.

It can be appreciated the sensor 100 surface 102 can be covered with a bio-film, customized for essentially any molecule for which detection is desired. This bio-film provides the analytical specificity. There are a wide variety of bio-film attachment methodologies to choose from and most preferably the sensor 100 is compatible with all assay formats, including direct binding, sandwich, competition, inhibition and displacement assays.

In view of the above, it can be seen the present invention presents a significant advancement in the art of low-cost, portable electronic biosensor platform technology. Further, this invention has been described in considerable detail in order to provide those skilled in the biosensor art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A portable analyzer for detecting properties of a given sample analyte comprising:
a housing having a bio-sensor mounting socket embedded therein; and
a miniature electromechanical vibration device attached to the socket such that energizing the vibration device causes the vibration device to vigorously shake the socket.

2. The portable analyzer according to claim 1 further comprising a bio-sensor plugged into the socket such that the energizing of the vibration device will further cause the vibration device to vigorously shake the sensor.

3. The portable analyzer according to claim 2 further comprising a fluid compartment having a liquid sample having an analyte suspended or dissolved therein, wherein the liquid sample is in fluid communication with the bio-sensor, and further wherein the energizing of the vibration device will further cause the vibration device to vigorously agitate the fluid compartment to cause the analyte suspended or dissolved in the liquid sample to accelerate the mass transport of analyte beyond that available in the absence of agitation.

4. The portable analyzer according to claim 3 further comprising:
a data processing device;
a data input device in communication with the data processing device;
an algorithmic software directing the data processing device; and
a data storage unit, wherein discrete analyte data associated with the liquid sample is stored and supplied to the data processing device such that the data processing device, directed by the algorithmic software, will automatically determine bioanalytical data associated with the liquid sample, wherein predetermined parameters associated with the bioanalytical data are determined via the data input device.

5. The portable analyzer according to claim 4 wherein the data processing device is a digital signal processor.

6. The portable analyzer according to claim 5 wherein the data input device is a keypad.

7. The portable analyzer according to claim 2 wherein the biosensor comprises an optically based miniaturized sensor.

8. A portable analyzer for detecting properties of a given sample analyte comprising:
a bio-sensor; and
a miniature electromechanical vibration device configured to vigorously shake the biosensor.

9. The portable analyzer according to claim 8 further comprising a fluid compartment configured to receive a liquid sample having an analyte suspended or dissolved therein such that the liquid sample is in fluid communication with the biosensor, and further wherein the energizing of the vibration device will further cause the vibration device to vigorously agitate the fluid compartment to cause the analyte suspended or dissolved in the liquid sample to accelerate the mass transport of analyte beyond that available in the absence of agitation.

10. The portable analyzer according to claim 9 further comprising:
a data processing device;
a data input device in communication with the data processing device;
an algorithmic software directing the data processing device; and
a data storage unit, wherein discrete analyte data associated with a liquid sample is stored and supplied to the data processing device such that the data processing device, directed by the algorithmic software, will automatically determine bioanalytical data associated with the liquid sample, wherein predetermined parameters associated with the bioanalytical data are determined via the data input device.

11. The portable analyzer according to claim 10 wherein the data processing device is a digital signal processor.

12. The portable analyzer according to claim 10 wherein the data input device is a keypad.

13. The portable analyzer according to claim 8 wherein the biosensor comprises an optically based miniaturized sensor.

14. A portable analyzer for detecting properties of a given sample analyte comprising:
a biosensor;
a fluid compartment in fluid communication with the bio-sensor; and
a miniature electromechanical vibration device configured to vigorously shake the fluid compartment.

15. The portable analyzer according to claim 14 wherein the miniature electromechanical vibration device is further configured to vigorously agitate the contents of the fluid compartment.

16. The portable analyzer according to claim 14 wherein the fluid compartment is configured to receive a liquid sample having an analyte suspended or dissolved therein, and further wherein the vibration device is configured to vigorously agitate the fluid compartment to cause an analyte suspended or dissolved in the liquid sample to accelerate the mass transport of analyte beyond that available in the absence of agitation.

17. The portable analyzer according to claim 14 wherein the biosensor comprises an optically based miniaturized sensor.

18. The portable analyzer according to claim 14 wherein the fluid compartment comprises:
a fluid chamber; and
a lid configured to open and close such that a liquid or solid sample having a first analyte suspended therein can be sealed within the chamber.

19. The portable analyzer according to claim 18 wherein the lid comprises a second analyte embedded therein such that agitation of the fluid compartment causes the second analyte to mix with the liquid or solid sample sealed within the chamber.

20. A portable analyzer for detecting properties of a given sample analyte comprising:
a biosensor;
a fluid compartment in fluid communication with the bio-sensor; and
a miniature electromechanical vibration device configured to vigorously shake the biosensor.

21. The portable analyzer according to claim 20 wherein the miniature electromechanical vibration device is further configured to vigorously shake the fluid compartment.

22. The portable analyzer according to claim 20 wherein the fluid compartment is configured to receive a liquid sample having an analyte suspended or dissolved therein, and further wherein the vibration device is configured to vigorously shake the fluid compartment to cause the analyte suspended or dissolved in the liquid sample to accelerate the mass transport of analyte beyond that available in the absence of agitation.

23. The portable analyzer according to claim 20 wherein the biosensor comprises an optically based miniaturized sensor.

24. The portable analyzer according to claim 20 wherein the fluid compartment comprises:
a fluid chamber; and
a lid configured to open and close access to the fluid chamber such that a liquid or solid sample having a first analyte suspended therein can be sealed within the chamber.

25. The portable analyzer according to claim 24 wherein the lid comprises a second analyte embedded therein such that agitation of the fluid compartment causes the second analyte to mix with the liquid or solid sample sealed within the chamber.

26. A portable analyzer for detecting properties of a given sample analyte comprising:
a biosensor having a sensing surface;
a sample compartment configured to receive a sample having an analyte suspended therein; and
a miniature electromechanical vibration device configured to vigorously shake the sample compartment to cause a desired portion of the analyte to contact the sensing surface of the biosensor.

27. The portable analyzer according to claim 26 wherein the biosensor comprises an optically based miniaturized sensor.

28. The portable analyzer according to claim 26 further comprising a sealing element configured to selectively seal the sample compartment.

29. The portable analyzer according to claim 28 wherein the sealing element comprises a septum.

30. The portable analyzer according to claim 28 wherein the sealing element comprises a removable cap.

31. The portable analyzer according to claim 28 wherein the sealing element comprises a hinged cap.

32. The portable analyzer according to claim 26 wherein the sample comprises at least one form selected from the group consisting of a liquid and a solid.

33. The portable analyzer according to claim 26 further comprising at least one secondary reagent associated with the sample chamber such that the shaking of the sample compartment will cause analyte from a sample contained therein to mix with the secondary reagent.

34. The portable analyzer according to claim 33 wherein the secondary reagent is embedded in the sample chamber.

35. The portable analyzer according to claim 33 wherein the secondary reagent is embedded in the sealing element.

36. The portable analyzer according to claim 26 wherein the sample compartment is configured to receive a liquid sample having an analyte suspended or dissolved therein, and further wherein the vibration device is configured to vigorously shake the sample compartment to cause the analyte suspended or dissolved in the liquid sample to accelerate the mass transport of analyte beyond that available in the absence of agitation.

37. The portable analyzer according to claim 26 further comprising:
a data processing device;
a data input device in communication with the data processing device;
an algorithmic software directing the data processing device; and
a data storage unit, wherein discrete analyte data associated with a sample contained within the sample compartment is stored and supplied to the data processing device such that the data processing device, directed by the algorithmic software, will automatically determine bioanalytical data associated with the sample, wherein predetermined parameters associated with the bioanalytical data are determined via the data input device.

38. The portable analyzer according to claim 37 wherein the data processing device is a digital signal processor.

39. The portable analyzer according to claim 37 wherein the data input device is a keypad.

40. The portable analyzer according to claim 26 further comprising means for transmitting and receiving data via a wireless communications link.

41. The portable analyzer according to claim 40 wherein the means for transmitting and receiving data comprises a radio frequency receiver and a radio frequency transmitter.
